(19) United States
(12) Patent Application Publication
(10) Pub. No.: US 2014/0228486 A1
(43) Pub. Date: Aug. 14, 2014

(54) SIZING COMPOSITIONS AND METHODS OF THEIR USE

(71) Applicants: Florence Garesio, Chambery (FR); Patrick Moireau, Curienne (FR)

(72) Inventors: Florence Garesio, Chambery (FR); Patrick Moireau, Curienne (FR)

(73) Assignee: OCV Intellectual Capital, LLC, Toledo, OH (US)

(21) Appl. No.: 14/235,888

(22) PCT Filed: Jul. 31, 2012
(86) PCT No.: PCT/US2012/048937

§ 371 Date: Mar. 25, 2014

Related U.S. Application Data
(60) Provisional application No. 61/513,868, filed on Aug. 1, 2011.

(51) Int. Cl. C03C 25/26; C03C 25/40; C03C 25/32

(52) U.S. Cl. CPC C03C 25/26; C03C 25/326; C03C 25/328; C03C 25/40
USPC 524/27; 428/392

(57) ABSTRACT

A sizing composition includes a texturing agent, a film-forming agent, and organic particles dispersed therein. A glass fiber strand is formed from a plurality of individual glass fibers coated with the sizing composition. A thermoplastic composite material includes such glass fiber strands.

### CROSS REFERENCE TO RELATED APPLICATIONS

This application is the U.S. national phase entry of PCT/US2012/048937 with an international filing date of Jul. 31, 2012, which claims priority to and any other benefit of prior U.S. provisional application Ser. No. 61/513,868, filed Aug. 1, 2011, the disclosures of which are both incorporated herein by reference in their entirety.

### FIELD

The present disclosure relates to sizing compositions for glass fiber strands suitable for reinforcing thermoplastic composites, the glass fiber strands obtained by coating glass fibers with said sizing compositions, and the thermoplastic composites incorporating said glass fiber strands.

### BACKGROUND

Reinforcing glass strands are conventionally prepared by mechanically drawing molten glass streams flowing by gravity from multiple orifices of bushings filled with molten glass to form filaments which are gathered together into base strands, and then collected. During the drawing of the glass filaments, and before they are gathered together into strands, the glass filaments are coated with a sizing composition, generally an aqueous sizing composition, using a rotating roll. The role of the sizing composition (also referred to as “size”) is two-fold:

1) during the manufacture of the strands, the size protects the filaments from the abrasion resulting from the rubbing of the filaments at high speed over the members of the process, thus acting as lubricant. It also makes it possible to remove the electrostatic charges generated during this rubbing. Finally, it gives cohesion to the strand by providing bonding of the filaments to one another; and

2) during the production of reinforced materials, the size improves the wetting of the glass and the impregnation of the strand by the material to be reinforced. It also promotes adhesion between the glass and the material, thus resulting in composite materials having improved mechanical properties.

The most commonly employed sizing compositions are aqueous compositions and, in particular, aqueous sizing compositions including a film-forming agent which exhibits in particular the advantages of giving mechanical cohesion to the final size and protecting the strands against mechanical damage and attacks from chemicals and the environment. These sizing compositions are comprised of more than 80% by weight of water and consequently have a low viscosity, generally at most equal to 5 centipoise (cP), which allows them to be easily deposited with relatively simple sizing devices, for example using a rotating roll over which the glass filaments pass at high speed. However, the following drawbacks occur due to the presence of water in such a high amount:

1) the sizing composition does not adhere well to the glass when the strand comes into contact with the various elements which act to guide it to the winder; a draining phenomenon occurs, followed by centrifugal projection of the size under the effect of the drawing speed; and

2) water has to be removed by drying the packages of strand, which brings about selective migration of the constituents of the size as a function of their affinity for water and their molecular weight, essentially from the inside to the outside of the package; as a result, the properties of the strand are not constant over the entire length of the package, which is reflected in particular by processing problems in weaving operations and the appearance of impregnation defects (e.g., white spots) in composites having an organic matrix. One way to overcome the latter disadvantage is to include a texturing agent into the size as reported in WO 2009/044042. The texturing agent confers the appearance of a physical gel to the size.

Glass strands (formed from glass filaments coated with a size) in their various forms (continuous, chopped or milled strands, mats of continuous or chopped strands, meshes, wovens, knits, and the like) are commonly used to reinforce various matrices, for example, thermoplastic or thermosetting materials and cement.

It would be more advantageous to obtain reinforced thermoplastic composites directly from glass strands without the need to add the strands to a thermoplastic matrix, e.g., a polyamide resin or a PET resin.

### SUMMARY

It has now been found that thermoplastic composites can be directly obtained from glass strands coated with a sizing composition containing organic particles.

Accordingly, a first aspect of the present disclosure relates to a sizing composition comprising a coupling agent, a film-forming agent, a texturing agent and organic particles dispersed in the composition. In one embodiment, the coupling agent comprises a silane or a mixture of silanes. In another embodiment, the film-forming agent comprises a compound selected from a polyvinyl acetate, an epoxy compound, a polyurethane, and mixtures thereof. In another embodiment, the texturing agent comprises a succinoglycan. In yet another embodiment, the organic particles are polymer particles, and in some embodiments polyamide particles.

Another aspect of the disclosure relates to a process for preparing the sizing composition. In one embodiment, the process comprises adding the texturing agent after the coupling agent, the film former, and the polymer particles have been mixed.

A further aspect of the disclosure relates to glass strands coated with the sizing composition.

Yet a further aspect of the disclosure relates to thermoplastic composite materials made from the glass strands coated with the sizing composition.

### BRIEF DESCRIPTION OF THE FIGURE

FIG. 1 shows the structure of a xanthan and of a succinoglycan used in a sizing composition, according to one exemplary embodiment.

### DETAILED DESCRIPTION

A sizing composition comprising by weight (dry extract solids content):

10 to 90% by weight of organic particles;

0.1 to 6% by weight of a texturing agent;

5 to 60% by weight of a film-forming agent;

0.1 to 6% by weight of a compound selected from a surfactant, a plasticizing agent, a dispersing agent, and mixtures thereof;

0.1 to 10% by weight of a coupling agent; and

0 to 15% by weight of at least one additive.

The particles dispersed in the sizing composition may be polymer particles. In one embodiment, the polymer is selected from a polyamide, a polytetrafluoroethylene, a polyvinylchloride, a polyester, a polypropylene, a polyphenylenesulfide, a polyethyleneimine, a polyamideimine, a polyether-etherketone, a polyoxymethylene, a polyethylene, copolymers thereof, and mixtures of said polymers and/or copolymers. In some embodiments the polymer comprises a polyamide or a mixture of polyamides. The content of particles (dry extract solids content) may be in the range from 5 to 55% by weight, or in the range from 15 to 50% by weight. The particles may have a size in the range from 0.5 to 50 μm and in some embodiments in the range from 2 to 30 μm (average diameter as determined by laser granulometry).

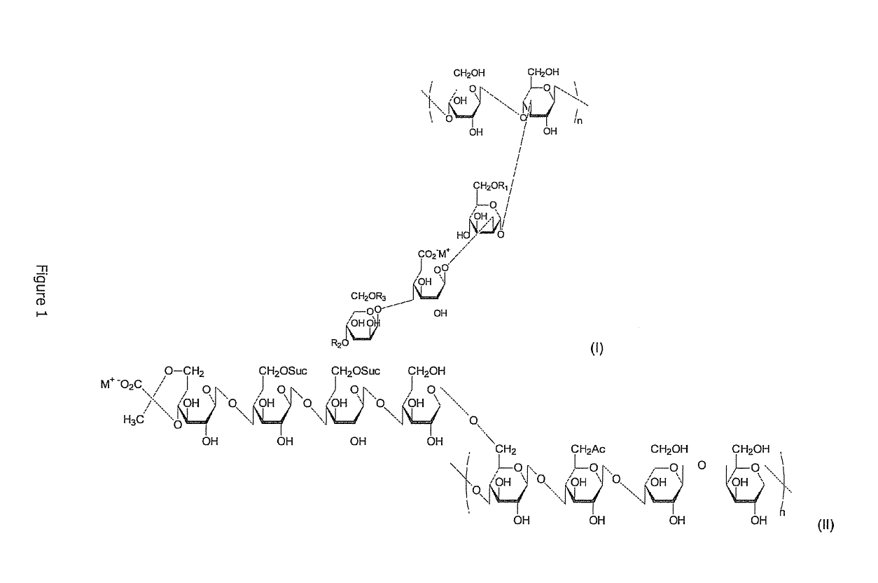

The texturing agent used in the sizing composition of the disclosure is a polysaccharide, such as a xanthan or a succinoglycan. In one embodiment, the xanthan is represented by formula (I) as shown in FIG. 1 in which:

M=Na, K or ½ Ca;

R₁=H or —COCH₃;

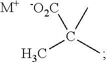

R₂ and R₃=H or

or R₂=H and R₃=—COCH₃.

In another embodiment, the succinoglycan is represented by formula (II) as shown in FIG. 1 in which:

Ac=—COCH₃;

Suc=—CO(CH₂)₂COOH;

M=Na, K or ½ Ca;

n≧80.

In some embodiments, the content of texturing agent (dry extract solids content) is in the range from 0.1 to 2% by weight of the sizing composition.

The film-forming agent plays several roles: it makes it possible to protect the glass filaments from abrasion during drawing, on the one hand, and the strand from attacks from chemicals and the environment, on the other hand; it also confers integrity on the strand; finally, it improves the compatibility of the sizing composition with the matrix to be reinforced. The choice of the film-forming agent depends largely on the chemical nature of the material to be reinforced.

The film-forming agent is selected from polyvinyl acetates (homopolymers or copolymers, for example, copolymers of vinyl acetate and of ethylene), polyesters, polyethers, epoxy compounds, polyacrylics (i.e., homopolymers or copolymers of derivatives of acrylic acid), polyurethanes, and mixtures thereof. The film-forming agent may be selected from polyvinyl acetates, epoxy compounds, polyurethanes, and mixtures thereof. In some embodiments, the content of film-forming agent (dry extract solids content) is in the range from 5 to 50% by weight of the sizing composition. The film-forming agent is generally introduced into the sizing composition in the form of an emulsion.

The sizing composition may also comprise a surfactant, a plasticizing agent and/or a dispersing agent, the role of which is to promote suspension and to make possible homogeneous dispersion of the various constituents of the composition while preventing problems of separation of the liquid phases, and to provide efficient and rapid wetting of the strands during the manufacture of the composites.

The surfactants, plasticizing agents, and dispersing agents include:
aliphatic or aromatic polyalkoxylated compounds which are optionally halogenated, such as ethoxylated/propoxylated alkylphenols, in some embodiments including 1 to 30 ethylene oxide groups and 0 to 15 propylene oxide groups, ethoxylated/propoxylated bisphenols, in some embodiments including 1 to 40 ethylene oxide groups and 0 to 20 propylene oxide groups, ethoxylated/propoxylated fatty alcohols, the alkyl chain of which may comprise 8 to 20 carbon atoms and including 2 to 50 ethylene oxide groups and up to 20 propylene oxide groups. These polyalkoxylated compounds can be block or random copolymers;
polyalkoxylated, for example polyethylene glycol, fatty acid esters, the alkyl chain of which may comprise 8 to 20 carbon atoms and including 2 to 50 ethylene oxide groups and up to 20 propylene oxide groups,
amine-comprising compounds, for example amines, which are optionally alkoxylated, amine oxides, alkylamides, sodium, potassium or ammonium succinates and taurates, sugar derivatives, in particular of sorbitan, alkyl sulphates, which are optionally alkoxylated, alkyl phosphates and ether phosphates of sodium, potassium or ammonium, which are optionally alkylated or alkoxylated.

The total amount of surfactant, plasticizing agent, dispersing agent, or combinations thereof in the sizing composition (dry extract solids content) may be in the range from 0.15 to 3.5% by weight.

The coupling agent facilitates the attaching of the size to the surface of the glass. The coupling agent may be a hydrolysable compound, for example a compound which can be hydrolysed in the presence of an acid, such as acetic, lactic or citric acid. In one embodiment, the coupling agent is selected from silanes, such as γ-glycidoxypropyltrimethoxysilane, γ-acryloyloxypropyltrimethoxysilane, γ-methacryloyloxy-propyltrimethoxysilane, poly(oxyethylene/oxypropylene)-trimethoxysilane, raminopropyltriethoxysilane, vinyltrimethoxysilane, phenylaminopropyltrimethoxy-silane, styrylaminoethylaminopropyltrimethoxysilane and tert-butylcarbamoylpropyltrimethoxysilane; siloxanes, such as 1,3-divinyltetraethoxydisiloxane; titanates; zirconates, in particular of aluminium; and mixtures thereof. The coupling agent may be a silane or a mixture of silanes. The amount of coupling agent in the sizing composition (dry extract solids content) may be in the range from 0.15 to 6% by weight.

The sizing composition may include one or several additives, in particular:
lubricants, such as a fatty acid ester, which is optionally alkoxylated, for example decyl laurate, isopropyl palmitate, cetyl palmitate, isopropyl stearate, butyl stearate, isobutyl stearate, trimethylolpropane trioctanoate and trimethylolpropane tridecanoate, an alkylphenol derivative, for example, ethoxylated octylphenol, a fatty alcohol, which is optionally alkoxylated, for example, polyethylene glycol laurate or stearate comprising methyl endings, in some embodiments comprising less than 10 oxyethylene units, fatty amine salts, a mineral oil, or mixtures thereof;
complexing agents, such as an EDTA derivative, a gallic acid derivative or a phosphonic acid derivative;
antifoaming agents, such as a silicone or a vegetable oil;
a polyol;
an acid used to control the pH during the hydrolysis of the coupling agent, for example acetic acid, lactic acid or citric acid;
cationic polymers, in particular those having a polyalkyleneimine backbone, such as those described in U.S. Pat. No. 6,399,741, the entire disclosure of which is hereby incorporated by reference. In one embodiment, the cationic polymer has 20% or less of reactive amino groups, in some embodiments from about 0.1% to about 10% reactive amino groups. The term “reactive amino group” is intended to mean any primary or secondary nitrogen atom in the polyalkyleneimine. Suitable polyalkyleneimines include any polyalkyleneimine having reactive amino groups suitable for reaction with a carboxylic acid, in particular carboxylic acids having from 2 to 18 carbon atoms, in some embodiments from 2 to 9 carbon atoms. In some embodiments the polyalkyleneimine is a polyethyleneimine, particularly a polyethyleneimine having a molecular weight of from about 1000 to about 2000;
compounds which make it possible to control the amount of free hydroxyl groups present in the sizing composition after the stage of drying the strand in order to have a weak hydrophilic nature, allowing good resistance to aging in a humid environment to be retained; such compounds are chosen from:
   epoxy compounds such as aliphatic epoxy compounds, such as butyl glycidyl ether, 1,4-butanediol diglycidyl ether and polyoxyethylene diglycidyl ethers comprising at most 4 ethylene oxide units, cycloaliphatic epoxy compounds, such as cyclohexane-dimethanol diglycidyl ether, or aromatic epoxy compounds, such as phenyl diglycidyl ether;
   masked isocyanates which can be thermally activated, which may be mono- or difunctional and which have a molecular weight of less than 1000, in some embodiments less than 700, such as isocyanates including one or more N-oxime, N-caprolactam and furfural groups. The unmasking temperature must correspond to the temperature for drying the strand, generally between 105° and 140° C.

A catalyst of the tertiary amine type may be used in combination with the epoxy compound or with the isocyanate. The catalyst can be chosen from known compounds, for example substituted phenols, such as tris(dimethylaminomethyl)phenol, and imidazolines, such as N-stearylimidazoline, or their derivatives. When used, the amount of catalyst does not exceed 1% by weight (dry extract solids content) of the sizing composition.

In some embodiments, the total content of additives in the sizing composition is in the range from 1 to 10% by weight, in some embodiments from 1 to 5% by weight (dry extract solids content).

The amount of water to be used to prepare the sizing composition is determined so as to obtain a solids content (dry extract) which varies from about 10 to about 60%, in some embodiments from about 15% to about 55% by weight.

The sizing composition according to the disclosure may have a viscosity in the range from about 20 to about 1100 cP, in some embodiments from about 100 to about 800 cP (as measured with a Brookfield Viscometer at 20° C. with a #2 or #3 spindle).

The sizing composition can be prepared by a process comprising the steps of:

a) hydrolysing the coupling agent;

b) adding the surfactant, the dispersing agent, the plasticizing agent and optionally the additive(s) to the hydrolysed coupling agent;

c) adding the inorganic or organic particles to the resulting mixture;

d) adding the film-forming agent to the mixture; and

e) adding the texturing agent to the mixture.

It is essential to add the texturing agent at the end of the process to obtain a homogeneous gel. In some exemplary embodiments, a dispersant (in some embodiments, that used in step b)) and other additives such as an antifoaming agent can be added at the end of step c) and/or at the end of step d). In some exemplary embodiments, water can be added at the end of step d) or at the end of step e) to adjust the solids content of the sizing composition to the desired value. In the latter case, it may be appropriate to add further texturing agent to adjust the viscosity of the sizing composition. In one embodiment, steps c) and d) can be inverted. When the coupling agent is an aminosilane, it can be readily hydrolysed without any pH adjustment. When the coupling agent is another type of silane, its hydrolysis is typically carried out in a slightly acidic medium, e.g., pH 4-4.5, by the addition of an acid such as acetic acid, lactic acid or citric acid. In such a case, neutralization of the acidic medium is required to avoid reaction with anionic groups of the texturing agent (e.g., a xanthan or a succinoglycan), the pH being adjusted in the range of about 6 to about 12, in some embodiments in the range 7-8. Neutralization may be performed using ammonia.

The sizing composition of the disclosure can be used to prepare glass fiber strands. Thus, another aspect of the disclosure relates to a glass fiber strand comprising a plurality of individual glass fibers coated with the sizing composition as defined herein.

As used herein, the term “strands” means the base strands resulting from the gathering together under the bushing of a multitude of filaments, and the products derived from these strands, in particular the assemblies of these strands in the form of rovings. Rovings can be multi-end rovings, i.e., glass fibers gathered into a single strand and wrapped into a cylindrical package without twist. They may also be “direct” rovings with a count (or linear density) equivalent to that of assembled rovings obtained by gathering together filaments directly under the bushing and winding onto a rotating support.

The glass fibers used in the preparation of the strands in accordance with the disclosure can be made of any type of glass, and in some embodiments of E glass, E-CR glass, R glass, S glass or AR glass. In some embodiments E-CR and R glasses are used.

As mentioned above, the aqueous sizing composition is deposited on the filaments before they are gathered together into base strand(s). Water is usually removed by drying the strands after collection under temperature and duration conditions which make it possible to achieve a water content of less than 0.25%, in some embodiments of less than 0.1%. Generally, drying is carried out at a temperature which varies from 100° to 150° C. for 10 to 20 hours, depending on the type of package and the initial water content.

The amount of dry (organic) particles deposited on the glass fibers is in the range from about 2.5% to about 35% by weight, in some embodiments from about 5% to about 30% by weight, and in some other embodiments from about 5% to about 25% by weight.

The average diameter (as determined by optical microscopy) of the glass filaments constituting the strands can vary to a great extent, for example from about 5 to about 30 μm, in some embodiments from about 10 to about 20 μm. In the same way, the linear density of the strand can vary widely, from about 300 to about 4800 tex (bare glass value), depending on the application sought.

The glass fiber strands of the disclosure can be used as such as thermoplastic composite materials. A further aspect of the disclosure thus relates to a thermoplastic composite material comprising optionally woven glass fiber strands as defined above. The thermoplastic composite material may have a glass content in the range from about 65% to about 90% by weight, in some embodiments from about 70% to about 85% by weight. In such an embodiment, the content of dry particles deposited on the glass fibers is typically in the range from about 15% to about 35% by weight.

The glass fiber strands of the disclosure can also be used to manufacture thermoplastic preforms which can be subsequently processed e.g., by molding. In such an embodiment, the content of dry particles deposited on the glass fibers is typically in the range from about 2.5% to about 10% by weight.

The examples below illustrate exemplary embodiments of the disclosure.

### EXAMPLES 1-15

In these examples the following constituents were used.

### Polymer Particles

Orgasol® 1002 D NAT 1, available from Arkema: powder of polyamide 6
Orgasol® 2001 EXD NAT 1, available from Arkema: powder of polyamide 12

### Film-Forming Agent

Hydrosize® U10-01, available from Michelman: water-soluble polyurethane solution

### Coupling Agent

Silquest® A-1100, available from GE Silicones: gamma-aminopropyltriethoxysilane

### Dispersing Agent, Surfactant

Standapol® 2662, available from Pulcra Chemicals LLC: PEG600 monostearate
Solsperse® 20000, available from Lubrizol: dispersant

### Texturing Agent

Rheozan® SH, available from Rhodia: succinoglycan

### Additives

Tego Foamex® 830, available from Evonik Tego Chemie GmbH: antifoaming agent

The sizing composition was prepared as described below except otherwise indicated.

a) The coupling agent was hydrolysed by introducing it into a large volume of water (pH approximately 10-12). The mixture was stirred at room temperature for approximately 20 minutes.

b) The surfactant(s), the dispersing agent(s), the plasticizing agent(s) and optionally the additives were added, under stirring, to the solution of hydrolyzed silane(s).

c) The mixture obtained in step b) was gently poured onto the polymer particles, in the form of a powder, and the mixture was stirred until a homogeneous paste was obtained.

d) The film-forming agent was added; and then

e) The texturing agent was slowly added under stirring to the mixture obtained in step

d). The stirring speed was adjusted so that no agglomerates would form.

Viscosity was measured using a Brookfield LVF viscometer equipped with a spindle of LV type under the following conditions: the spindle was immersed in 500 g of sizing composition present in a cylindrical container with a diameter of 9 cm, the spindle (a No. 2 spindle (#2) or a No. 3 spindle (#3)) was rotated at 60 rpm for 1 minute, and the viscosity was measured at 20° C.; it is expressed in cP (mPa·s).

The loss on ignition (LOI) of glass strands was measured according to Standard ISO 1887 and is expressed as %.

The tenacity of glass strands was assessed by measuring the tensile breaking force under the conditions defined by Standard ISO 3341. It is expressed in N/tex.

The “fuzz” of glass strands makes it possible to assess the resistance to abrasion of a strand. It was measured by weighing the amount of material which separates from the strand after the latter has passed over a series of 2, 4, or 6 cylindrical ceramic bars positioned so that the deflection angle of the strand at each bar is equal to 90°. The amount of fuzz is given in mg per 1 kg of strand tested.

Sizing compositions comprising the constituents listed in Tables 1-3 were prepared. The content (wt %) of each individual constituent is expressed on a dry matter basis; the proportion of each constituent in the composition is also indicated (in brackets).

According to procedures well-known to those skilled in the art, the sizing compositions were applied using a “full bath” sizing roll to EC-R glass filaments which were then gathered together into a wound strand in the form of a roving. The roving was subsequently dried. The properties of the sizing compositions and of the glass strands are given in Tables 1-3.

The glass strands were then used to form thermoplastic composite materials comprising parallel strands by winding the strands on a mold and compressing them at a temperature of 260° C. for 10 min, thereby obtaining 3 mm thick plates.

TABLE 1

| | C. Ex. 1 | Ex. 1 | Ex. 2 | Ex. 3 | Ex. 4 | Ex. 5 | Ex. 6 |
|---|---|---|---|---|---|---|---|
| Silquest A1100 (% | 1.741 | 1.161 | 0.871 | 0.784 | 0.784 | 0.784 | 0.784 |
| comp) | (3) | (2) | (1.5) | (1.35) | (1.35) | (1.35) | (1.35) |
| Hydrosize U10-01 | 16.914 | 11.276 | 8.457 | 7.611 | 7.611 | 7.611 | 7.611 |
| (% comp) | (56.4) | (37.6) | (28.2) | (25.4) | (25.4) | (25.4) | (25.4) |
| Standapol 2662 (% | 1.344 | 0.896 | 0.672 | 0.605 | 0.605 | 0.605 | 0.605 |
| comp) | (1.3) | (0.9) | (0.7) | (0.6) | (0.6) | (0.6) | (0.6) |
| Rheozan (% comp) | 0.92 | 0.228 | 0.418 | 0.06975 | 0.06975 | 0.06975 | 0.06975 |
| | (0.9) | (0.2) | (0.4) | (0.07) | (0.07) | (0.07) | (0.07) |
| Orgasol 2001 EXD | 0 | 6.667 | 10.0 | 36.0 | 36.0 | 36.0 | 36.0 |
| NAT 1 | (0) | (6.7) | (10) | (36) | (36) | (36) | (36) |
| (% comp) | | | | | | | |
| Size | | | | | | | |
| Viscosity (cP) | 102 | 35 | 620 | 590 | 590 | 1060 | 300 |
| | (#2) | (#2) | (#2) | (#3) | (#3) | (#3) | (#3) |
| Solids content (%) | 20.9 | 20.2 | 20.4 | 45.1 | 45.1 | 45.1 | 45.1 |
| Strand | | | | | | | |
| LOI (%) (int/ext) | 0.93 | 1.30 | 1.84 | 14.8 | 15.3/15.4 | 17.8/16.6 | 19.4/18.7 |
| Linear density | 396 | 402 | 417 | 395 | 383 | 388 | 390 |
| (Tex) | 0.35 | 0.31 | 0.22 | 0.34 | 0.38 | 0.29/0.27 | 0.36/0.32 |
| Tenacity (N/Tex) | 11* | 35* | 278* | 83** | 257** | 7.6*** | 9.9*** |
| Fuzz (mg/kg) | | | | | | | |

*2 turn points;
**4 turn points;
***2 turn points;
int: internal;
ext: external

TABLE 2

| | Ex. 7 | Ex. 8 | Ex. 9 | Ex. 10 | Ex. 11 |
|---|---|---|---|---|---|
| Silquest A1100 (% | 0.871 (1.5) | 0.871 (1.5) | 0.522 (0.9) | 0.522 (0.9) | 0.522 (0.9) |
| comp) | | | | | |
| Hydrosize U10-01 (% | 8.457 (28.2) | 8.457 (28.2) | 5.074 (16.9) | 5.074 (16.9) | 5.074 (16.9) |
| comp) | | | | | |
| Standapol 2662 (% | 0.672 (0.7) | 0.672 (0.7) | 0.403 (0.4) | 0.403 (0.4) | 0.403 (0.4) |
| comp) | | | | | |
| Rheozan (% comp) | 0.7752 (0.8) | 0.7752 (0.8) | 0.6047 (0.6) | 0.6047 (0.6) | 0.6047 (0.6) |
| Orgasol 1002 D NAT 1 | 10.0 (10) | 10.0 (10) | 24.0 (24) | 24.0 (24) | 24.0 (24) |
| (% comp) | | | | | |
| Size | | | | | |
| Viscosity (cP) (#2) | 175 | 175 | 630 | 630 | 630 |
| Solids content (%) | 20.8 | 20.8 | 30.6 | 30.6 | 30.6 |
| Strand | | | | | |
| LOI (%) (int/ext) | 6.5/12 | 5.92/12 | 16.44/18.32 | 12.66/18.47 | 11.7/17.84 |
| Linear density (Tex) | 429 | 450 | 414 | 423 | 427 |
| Tenacity (N/Tex) | nd | nd | 0.34 | 0.31 | 0.33 |
| Fuzz (mg/kg) | 97 | 123 | 223.55 (int) | nd | 175 (ext) |

nd: not determined;
int: internal;
ext: external

TABLE 3

| | Ex. 12 | | Ex. 13 | | Ex. 14 | | Ex. 15 | |
|---|---|---|---|---|---|---|---|---|
| Silquest A1100 (% comp) | 0.522 | (0.9) | 0.784 | (1.35) | 0.784 | (1.35) | 0.784 | (1.35) |
| Hydrosize U10-01 (% comp) | 5.074 | (16.9) | 7.611 | (25.4) | 7.611 | (25.4) | 7.611 | (25.4) |
| Standapol 2662 (% comp) | 0.403 | (0.4) | 0.605 | (0.6) | 0.605 | (0.6) | 0.605 | (0.6) |
| Rheozan (% comp) | 0.6046 | (0.6) | 0.1047 | (0.1) | 0.2086 | (0.21) | 0.1043 | (0.1) |
| Orgasol 1002 D NAT 1 (% | 24 | (24) | 36 | (36) | 36 | (36) | 36 | (36) |
| comp) | | | | | | | | |
| Size | | | | | | | | |
| Viscosity (cP) | 620 | (#2) | 780 | (#3) | 1100 | (#3) | 380 | (#2) |

| | | | | |
|---|---|---|---|---|
| Solids content (%) | 30.6 | 45.1 | 45.2 | 45.1 |
| Strand | | | | |
| LOI (%) (int/ext) | 11/11.5 | 18.1/17.7 | 13.1/14.6 | 21.2/20.8 |
| Linear density (Tex) | 406 | 402 | 402 | 378 |
| Tenacity (N/Tex) (int/ext) | 0.41/0.35 | 0.34/0.29 | 0.35/0.29 | 0.39/0.39 |
| Fuzz (mg/kg) (2 turn points) | 145 | nd | nd | 134 |

nd: not determined;
int: internal;
ext: external

1. A sizing composition for glass fibers, the sizing composition comprising by weight of dry extract solids content:
10 to 90% by weight of polymer particles;
0.1 to 6% by weight of a texturing agent;
5 to 60% by weight of a film-forming agent;
0.1 to 6% by weight of at least one compound selected from a surfactant, a plasticizing agent, a dispersing agent, and mixtures thereof;
0.1 to 10% by weight of a coupling agent; and
0 to 15% by weight of at least one additive.

2. The sizing composition according to claim 1, wherein the polymer is at least one of a polyamide, a polytetrafluoroethylene, a polyvinylchloride, a polyester, a polypropylene, a polyphenylenesulfide, a polyethyleneimine, a polyamideimine, a polyether-etherketone, a polyoxymethylene, a polyethylene, copolymers thereof, and mixtures of said polymers and/or copolymers.

3. The sizing composition according to claim 2, wherein the polymer is a polyamide or a mixture of polyamides.

4. The sizing composition according to claim 1, wherein the polymer particles have a size in the range from 0.5 to 50 μm.

5. The sizing composition according to claim 1, wherein the texturing agent is a xanthan or a succinoglycan.

6. The sizing composition according to claim 1, wherein the film-forming agent is selected from at least one of a polyvinyl acetate, a polyester, a polyether, an epoxy compound, a polyacrylic, a polyurethane, and mixtures thereof.

7. The sizing composition according to claim 1, wherein the coupling agent is a silane or a mixture of silanes.

8. The sizing composition according Claim 1, having a viscosity in the range from about 20 cP to about 1100 cP.

9. A glass fiber strand comprising a plurality of individual glass fibers coated with the sizing composition according to claim 1.

10. The glass fiber strand according to claim 9, wherein the amount of dry particles deposited on the glass fiber strand is in the range from about 2.5% to about 35% by weight.

11. The glass fiber strand according to claim 9, wherein the glass fibers are made from E glass, E-CR glass, R glass, S glass, or AR glass.

12. A thermoplastic composite material comprising glass fiber strands as defined in claim 9.

13. The thermoplastic composite material according to claim 12, having a glass content in the range from about 65% to about 90% by weight.

14. A sizing composition for glass fibers, the sizing composition comprising by weight of dry extract solids content:
10 to 90% by weight of polymer particles, wherein the polymer is at least one of a polyimide, a polytetrafluoroethylene, a polyvinylchloride, a polyester, a polypropylene, a polyphenylenesulfide, a polyethyleneimine, a polyamideimine, a polyether-etherketone, a polyoxymethylene, a polyethylene, copolymers thereof, and mixtures of said polymers and/or copolymers;
0.1 to 6% by weight of a texturing agent, wherein the texturing agent is a polysaccharide selected from a xanthan or a succinoglycan;
5 to 60% by weight of a film-forming agent;
0.1 to 6% by weight of at least one compound selected from a surfactant, a plasticizing agent, a dispersing agent, and mixtures thereof;
0.1 to 10% by weight of a coupling agent; and
0 to 15% by weight of at least one additive.

15. The sizing composition according to claim 14, wherein the polymer particles have a size in the range from 0.5 to 50 μm.

16. A glass fiber strand comprising a plurality of individual glass fibers coated with the sizing composition according to claim 14.

17. A thermoplastic composite material comprising glass fiber strands as defined in claim 16.

18. The theiinoplastic composite material according to claim 17, having a glass content in the range from about 65% to about 90% by weight.
